(19) United States
(12) Patent Application Publication
(10) Pub. No.: US 2011/0238440 A1
(43) Pub. Date: Sep. 29, 2011

(54) Intelligent Particle Beam Allocation System and Related Method for Treatment in Multi-Room Medical Centers

(76) Inventor: Mark B. Leuschner, Bloomington, IN (US)

(21) Appl. No.: 13/073,640

(22) Filed: Mar. 28, 2011

Related U.S. Application Data
(60) Provisional application No. 61/318,681, filed on Mar. 29, 2010.

(51) Int. Cl. G06Q 50/00; G06Q 10/00

(52) U.S. Cl. 705/2

(57) ABSTRACT

A computer-implemented system and method for controlling work flow management to improve the operational efficiency of a multi-room particle therapy medical center are disclosed. In one embodiment, the system includes a monitoring system configured through an active connection to receive real-time information about the current actions of the people, hardware and software at the center, an analysis system configured through an active connection to synthesize the information attained through the monitoring system, and a control system configured through an active connection that uses information acquired by the monitoring system to continuously update information made available through a set of user interfaces to an end user. Features also are provided to automatically synchronize, obtain, and update status information on the shared resources in the particle therapy medical center. Various ways of handling the data aggregation issues associated with compiling status data are also described.

### CROSS-REFERENCE TO RELATED APPLICATIONS

This application claims the benefit under 35 U.S.C. 119 of U.S. Provisional Patent Application No. 61/318,681, filed Mar. 29, 2010, titled “Intelligent Particle Beam Allocation System and Related Method for Treatment in Multi-Room Treatment Centers”. This application is herein incorporated by reference in its entirety.

### INCORPORATION BY REFERENCE

All publications and patent applications mentioned in this specification are herein incorporated by reference to the same extent as if each individual publication or patent application was specifically and individually indicated to be incorporated by reference.

### FIELD OF THE INVENTION

This application relates to the prediction of shared resources for efficient utilization in the radiation therapy context. More particularly, this application is directed to efficient patient scheduling for a radiation therapy center that utilized a single radiation source among more than one treatment room.

### BACKGROUND OF THE INVENTION

In some radiation therapy treatment regimes, a single radiation source is shared by a number of patient treatment rooms. The radiation source can be any source that generates X-ray beams, proton beams, heavy ion beams such as carbon ion beams, beta ray beams, positron beams, antiproton beams, neutron beams, alpha ray beams, infrared ray beams, visible ray beams, and ultraviolet ray beams. For example, in some embodiments, the radiation source generates photon or proton beams suitable for treatment of cancer, or X-ray beams suitable for treatment or diagnostic imaging of cancer. Various radiation sources are known to those skilled in the art.

By way of example, one such single radiation source for proton therapy is where the protons are generated from a source such as a synchrotron or a cyclotron. In a multi-room medical center that shares a single radiation source, a treatment room must be “selected” in order for the operator of the radiation source to deliver particle beam to said treatment room. The selection process includes turning the appropriate magnets on and tuning the field strength of the beam delivery system so that the proton beam is correctly directed from the source to one of the multiple treatment rooms where the beam is applied to a patient. The operator must also de-energize magnets in the beam line leading to the room where the beam was most recently delivered. The status of the radiation source at the time a beam request is made by one of the treatment rooms can be one of the following: selected, switching, busy or wrong. “Selected” means that the requesting treatment room is already selected for beam delivery and there is no waiting time for beam. “Switching” means that the radiation source operator is in the process of switching the room selection to the requesting treatment room. “Busy” means that the radiation source is busy delivering beam to another treatment room at the time of the beam request, and “wrong” means that the radiation source is idle at the time of the beam request, and that the wrong treatment room is selected.

In order to ensure the efficiency of the medical center, one has to know when the shared resources will be needed, when the beam will be needed in a specified treatment room, then start a new patient in the intake process at the right time to meet the timing expectation of the shared resources. The right time depends on the patient queue as well as the complexity of the planning and preparation in advance of the patient's treatment. There are also uncontrolled variables in the patient intake management process. Overloading the system and developing a backlog of patients who are in the queue awaiting treatment are to be avoided.

Nevertheless, knowing the time that the patient setup begins allows the operator to correctly predict the beam request two thirds of the time. The result of predictive room selection can be as great as 40% of the time the room selection is complete and the treatment room experiences no waiting time, and 16.6% of the time the room selection is in progress and the treatment room wait is minimal.

What is needed are improved scheduling techniques to provide for efficient use of shared resources such as the medical staff, the patient staging areas, the radiation source, and the like, while reducing the wait time for patients to receive treatment.

### SUMMARY OF THE INVENTION

The invention provides a system and method of a computer-implemented work flow management system to improve the operational efficiency of a multi-room medical center. An embodiment of the invention is to provide a solution for the personnel of a medical center to manage the patient flow from intake through to treatment. Aspects of the present invention include the application of intelligent radiation source control through queuing system techniques. This queuing system provides a solution to assist the personnel of a medical center in the delivery of the therapy on the treatment day.

According to one embodiment of the invention, a computer implemented system for tracking and directing work flow in a particle therapy medical center, comprising: a monitoring system configured to receive real-time information about the current actions of people, hardware, and software at the medical center from the people, hardware, and software at the medical center; an analysis system configured to analyze the information received by the monitoring system to construct probability distributions for each step in a treatment process of the medical center; and a control system configured to use the probability distributions from the analysis system to predict demands on shared resources, provide strategies for dealing with the demands, and output the demands and strategies. The control system provides the capability of making predictions for demands on shared resources and provides strategies for dealing with said predictions.

According to another embodiment of the invention, the systems and methods of the present queuing system of the radiation source process employ an algorithm to predict the beam priority, instruct the radiation source to preemptively change its room selection in anticipation of a pending beam request, and be prepared to deliver beam elsewhere. A method comprised the steps of initiating collection of information; compiling said information into a dataserver which tracks the status of each task of work flow in the medical center; incorporating said information into a repository for data analysis; processing said status information by determining the appropriate work flow functions to be executed next; and initiating execution of next work flow function in response to command by an executable application used in implementing the work flow.

In another embodiment, a system is provided which includes a radio frequency identification (RFID) interrogator system positioned proximate to an intended path of a patient along corridors and rooms of the medical center; and, a plurality of passive RFID tags each having a unique tag ID containing encoded information which can be decoded, the RFID tags being positioned on patient badges, wherein the RFID interrogator system provides the capability of determining the location of the patient in said proximate environment based on the interrogation of said passive RFID tags. The RFID interrogator system provides data that the system uses to model the behavior work flow in a medical center and identify the process variables that most profoundly influence its behavior.

The present invention involves performing or completing certain selected tasks or steps automatically, manually, or a combination thereof. Several selected steps could be performed by a data processor, such as a computing platform for executing a plurality of instructions. Selected steps of the method and system of the invention could be implemented by hardware or by software on any operating system of any firmware or a combination thereof. For example, as hardware, selected steps of the invention could be implemented as a chip or a circuit. Selected steps of the invention could be implemented as a plurality of software instructions being executed by a computer using any suitable operating system.

Where not defined otherwise, all technical and scientific terms used herein have the same meaning as commonly understood by one of ordinary skill in the art of this invention. The materials, methods, and examples provided herein are not intended to be limiting and are only presented for illustrative purposes.

### BRIEF DESCRIPTION OF THE DRAWINGS

FIG. 1 illustrates how queuing system is interconnected and networked through the component systems, information inputs and outputs for the users.

FIG. 2 is a schematic of an exemplary multi-room radiation medical center.

### DETAILED DESCRIPTION OF THE INVENTION

The invention relates to a system and method of providing information on the current state of a particle therapy medical center, predicting the future state of the particle therapy medical center, generating and executing strategies to optimize center operations.

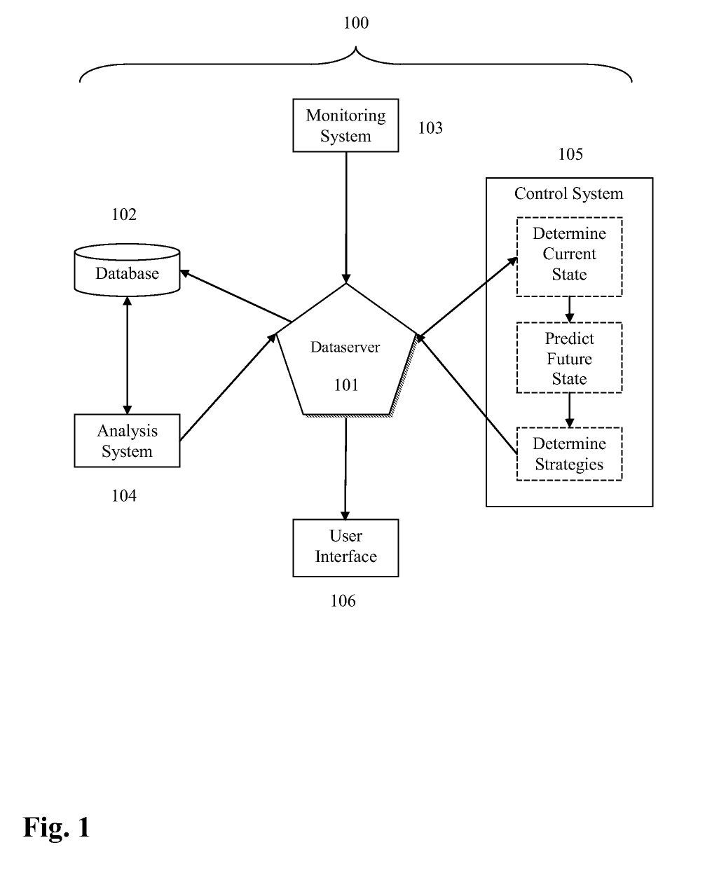

FIG. 1 shows the components of the queuing system according to one embodiment of the invention. The queuing system is a computer-implemented system that influences the manner in which the work flow of a particle therapy medial center occurs. The system of FIG. 1 generally includes a monitoring system 103, a dataserver 101, a database 102, an analysis system 104, a control system 105 and user interfaces 106. The queuing system provides a wholly integrated, universal communications, tracking, monitoring, analysis and control system for a particle therapy medical center. The system permits direct wireless communication among personnel, wireless access to continuously updated, stored information relating to patients, personnel and other assets, covert or automatic collection of information relating to the movement and status of such patients, personnel and other assets, and control (either manually or automatically) of equipment and environmental features of the facility based on activities and/or the movement or status of patients, personnel or other assets. Other assets can include, but not limited to, cyclotron, beam delivery system, treatment room equipment and information systems.

To assist the reader, the following terms are used in this specification and should be understood to have the following meanings, unless otherwise specified or made clear by the context.

The “work flow” as used herein throughout this description is understood to refer to the change in position and change in status from a point in time to the next point in time of patients, staff, medical devices, equipment or systems in the medical center. It can be know for instance when radiation is in a room, or when rooms are interlocked, or when beam switching is initiated.

The “queuing system” 100 implemented on a computer-readable storage medium for tracking and directing work flow in a medical center, comprising a dataserver 101; a monitoring system 103 configured to receive real-time information about the current actions taking place at the center; an analysis system 104 configured to analyze the information attained through said monitoring system 103; and a control system 105 configured to use information acquired by said monitoring system 104 and analyzed by the analysis system 104 to continuously update information made available through a user interface 106 to an end user. The end user can initiate an execution of next work flow function in response to the suggested strategy to be performed by an executable application used in implementing the work flow.

The “dataserver” 101 can be the central data management entity of the queuing system. All interactions between the various components of the queuing system can be coordinated through the dataserver 101. This ensures that the information in the queuing system is synchronized and current. The dataserver 101 can be responsible for managing all of the data in the entire queuing system. It can organize all of the data it receives and log it into a database 102. The dataserver 101 can immediately push the data it receives to all registered parties that need the current data, herein referred to as “listeners.” Data can be transferred to a listener through data communications pathways, both logical and physical, e.g. interprocess messaging, interprocessor data transmissions, and local and wide area data communications links.

The “monitoring system” 103 can perform real-time monitoring of people, hardware, and software, and determine the present state of the center. All of the external data can be received by the monitoring system 103. The sources of key inputs necessary for the monitoring system 103 to determine the present and future states of the center are the actions and information provided by the people, the hardware systems and the software systems. The “hardware system” includes, but is not limited to, a radio frequency identification (RFID) interrogator system, barcode scanners, radiation detectors, cyclotron and treatment room equipment. The components of the hardware system throughout the center can be monitored automatically, including the proton beam, the treatment room gantries, patient positioning systems and the beam interlock system.

The “radio frequency identification (RFID) interrogator system” can comprise RFID tags, interrogator elements (i.e. receivers or readers), a computer system and a database. The interrogator elements can be positionable within operable ranges of a plurality of said RFID tags during operation of the patient location system. The RFID interrogator system can use a plurality of passive RFID tags each having an unique tag ID containing encoded information which can be decoded. Each RFID tag can be positioned on patient badges. In instances where the patient cannot wear a badge, the badge with the RFID tag can be affixed to a patient transport such as a cart, bed, wheelchair, walker or anesthesia bed. RFID tags typically include an integrated circuit (IC) attached to an antenna—typically a small coil of wires—plus some protective packaging (e.g. a plastic card) as determined by the application requirements. RFID tags can come in many forms and sizes. Data is stored in the IC and transmitted through the antenna to a reader. Such passive RFID tags require no batteries.

Each interrogator element can be positioned in an environment proximate to an intended path of a patient along corridors of the medical center and rooms of a medical center to interrogate RFID tags at a given time. The environment comprises a patient surface movement area of a medical center, thereby providing enhanced situational awareness to staff as to the position of patients in the medical center. Interrogator elements are well known in the automatic data identification industry. The interrogation elements used should support the specific operating modes and frequencies of the RFID tags selected. They include a radio frequency (RF) transmitter and receiver, controlled by a microprocessor or digital signal processor. The interrogator element, using an attached antenna, captures data from tags then passes the data to a computer for processing. As with tags, readers come in a wide range of sizes and offer different features.

The interrogator system can include a computer system operatively connected to the interrogator element via a communication connection (e.g., an Ethernet, WiFi, or Bluetooth connection) so the server of the queuing system can understand the patient location. The computer system may be a standalone system or part of the monitoring system, for example. The computer system may have access to a database of the medical center's map information so that the location of the patient in the medical center can be determined based on the interrogation of the passive RFID tags. The location data from the computer system can be used for displaying the location on a display device operatively connected to the computer system. The RFID interrogator system can manage and organize the responses from the RFID tags based on algorithms described herein. Two examples of potential algorithms for managing responses are noted below:

Algorithm 1

1. RFID interrogator is instructed to obtain IDs of proximate RFID tags.

2. Tag IDs contain encoded information, for example, of the patient identification and position or location in the medical center, which can be decoded without reference to a database.

3. Display shows e.g. “IN RECEPTION” being derived from the decoded information for reception. This can be extended to show “IN RECPTION, PATIENT ADMITTED, APPROACHING PATIENT STAGING” when the decoded information indicates that the patient has indeed checked in with the receptionist, completed the admitting process, and is walking toward the patient staging area, if enough additional information is encoded into the RFID tags indicating to proximity to the RFID interrogator position.

Algorithm 2—Alternatively, a database of tag IDs could be used in conjunction with the encoding of Algorithm 1.

1. RFID interrogator is instructed to obtain IDs of proximate RFID tags.

2. Tag IDs are decoded and compared to a database of locations in the medical center to determine exactly where in the medical center the patient is located.

3. The display shows a map or perspective view of the medical center and the patient's position.

The “software system” includes, but is not limited to, information systems such as a treatment room schedule, oncology information systems (OIS) and the staff schedule. Information systems such as MosaiQ produced by ELEKTA, measures for security and regulatory compliance such as that required by the Health Insurance Portability and Accountability Act of 1996 (HIPPA). The human components providing inputs to the monitoring system 103 include such information as the location of staff and patients which are continuously monitored with RFID readers. Information from these main source categories can be continuously monitored and interpreted to determine the present state of the system. All of the monitored data can be logged in a database for offline analysis.

The “analysis system” 104 provides analysis on the patient intake management process of the work flow in the center. It performs the data and process mining for the statistical analysis that is relied upon by the control system 105. The analysis system includes, but not limited to, software systems that support data mining, process mining, simulation, report generation and optimization of operational work flow through the medical center. The analysis system operates using a computer system. The computer system may be a standalone system or part of a networked system operatively connected to the monitoring system 103 and the control system 105, for example. The analysis system can work offline to parse and analyze the data gathered by the monitoring system, then construct probability distributions for each step in the treatment process. All of the data it analyzes can be logged it into the database as well as being made available to the dataserver 101 and control system 105.

The analysis system is responsible for properly characterizing the probability distribution that is relevant to the process steps about to be undertaken. For instance, the distribution of switching times may depend on the rooms that the beam is being switched to and from. It may depend on the skill of the cyclotron operator who is executing the switch. It may depend on the clinical requirements of the beam to be delivered to the treatment room. The analysis system must provide a statistical distribution with the proper context.

The analysis system also reflects how compliant the work flow tasks are according to the strategies provided by the control system 105. Sometimes unforeseen factors can affect the work flow in the current state and thereby affect the predictions for the future state. For instance, the patient setup time can be dependent on a variety of factors including mobility, agility and overall health of the patient as well as the speed and ease of getting a patient secured in position devices such as masks or harnesses. It is not uncommon for patients to experience anxiety, nervousness and trepidation when being positioned in the treatment process. The analysis system also reflects the number of distinct paths there are in the work flow, what is the most frequent path, where are the bottlenecks, which paths are the most efficient, what is the communication structure and dependencies between staff, which steps in the work flow are correlated with other steps and which steps have the most predictive power. All of the treatment components that are influenced by these factors are modeled statistically. Improvements in work flow efficiency can be modeled by adjusting the relevant statistical distributions.

The probabilities of a beam request can be analyzed as well as the time distributions of the beam requests. The process and data and process mining the process provides us with the quantitative information needed to eliminate defects and improve quality and efficiency of the service provided. Process and data mining also reduce the variability and uncertainty in the intake process allowing the control system 105 users to make more accurate predictions on the patient intake and throughput and the overall management of the medical center and its resources.

The “control system” 105 is a computer-based system which may be a standalone system or part of a networked system operatively connected to the monitoring system, the analysis system, dataserver 101 and user interfaces 106, for example. The control system 105 uses the information acquired by the monitoring system 103 in conjunction with the information from the analysis system to continuously update the information provided in the user interfaces 106.

The control system 105 determines the “current state” of the center from the data it receives from the monitoring system, and performs the real-time prediction of the “future state” of the center using a statistical analysis based on the data that is provided by the analysis system 104. It then generates strategies for optimizing work flow to the end user which is typically the medical center personnel. For example, the control system 105 can adjust the pace of activities in each treatment room so that the likelihood of beam demand conflicts (i.e. when two or more treatment rooms request the beam at the same time) is minimized. This is accomplished through the use of a collection of computer algorithms that determine the present state of the center from a series of events passed to it from the monitoring system 103. The analysis system provides statistical information to the algorithms of the control system 105, which thereby enables the prediction of the future state of the center. The control system 105 can constantly update the operator of the radiation source with the progress in each of the four treatment rooms. When the control system 105 makes a definitive assessment of which treatment room will be ready to receive the proton beam first, the operator of the radiation source can preemptively start to prepare the beam for that patient and that room in anticipation of the beam request. When the patient setup is complete, the beam will therefore be prepared and ready when the therapists request it. While a core principle of the queuing system is to identify potential resource conflicts in a work flow process, the control system 105 provides the capability of not only changing the sequence of tasks in a work flow process, but also being capable of managing the timing of each of the tasks in the sequence.

The control system 105 preferably receives the monitoring system 103 data in real-time. It is a registered listener of the dataserver 101. The analysis system performs periodic offline analysis of the accumulated data from the monitoring system 103. It does not need the data in real-time. The analysis system is not a listener of the dataserver 101, it retrieves the data directly from the database.

The association between the control system 105 and the dataserver 101 can be bidirectional. The center state is determined from the events that the control system 105 receives from the monitoring system 103 via the dataserver 101. When the control system 105 updates its output, it passes it to the dataserver 101 so it can be disseminated to all of the registered listeners.

In general, throughout this description, “user interface” 106 or “end user” as used herein, is understood to comprise an individual user, a group or category of users, a role or characteristic of one or more users, a particular device or system such as a medical device or system, and the like, or a combination thereof. The users of a system may be able to access, modify or input patient or process specific information into the system. Furthermore, the users of the control system 105 are not limited to but typically include treatment room staff such as beam operators and medical personnel. Users such as the staff or employees of the medical center interact with the queuing system via a collection of computer interfaces. The user interfaces 106 that the center staff use must be updated continuously as the control system 105 updates, adjusts, evolves, and/or refines its output. The user interfaces 106 are therefore registered listeners of the dataserver 101.

Many of the user interfaces 106 are also associated with the dataserver 101 in a bidirectional manner. For the most part, the control system 105 perceives the state of the center indirectly via the monitoring system 103 (which is paying attention to various mechanical and electrical sources of information), but the user interfaces 106 provide the center staff an opportunity to inform the control system 105 in areas that are not electrically or mechanically transduced and passed to the monitoring system 103. For instance, if equipment malfunctions or a patient becomes sick, the center staff may inform the control system 105 that they are delayed in their progress in preparing a patient for treatment.

Additionally, “executable procedure” is meant to be understood to comprise software that exists within a software application which can be called by another software application or component of a software application, e.g. a work flow process or sub-process. It is understood that as used herein, an “executable procedure” may comprise a work flow sub-process, e.g. a configuration within a work flow engine that will result in task(s) being undertaken by people, computer systems, or a combination thereof such as through a call from a work flow executable procedure to another work flow executable procedure or other machine callable subroutine of executable code.

Although one or more components of the present invention will be described herein in object oriented programming terms as will be readily familiar to those of ordinary skill in the object oriented programming arts, the present invention is not limited to nor require object oriented programming.

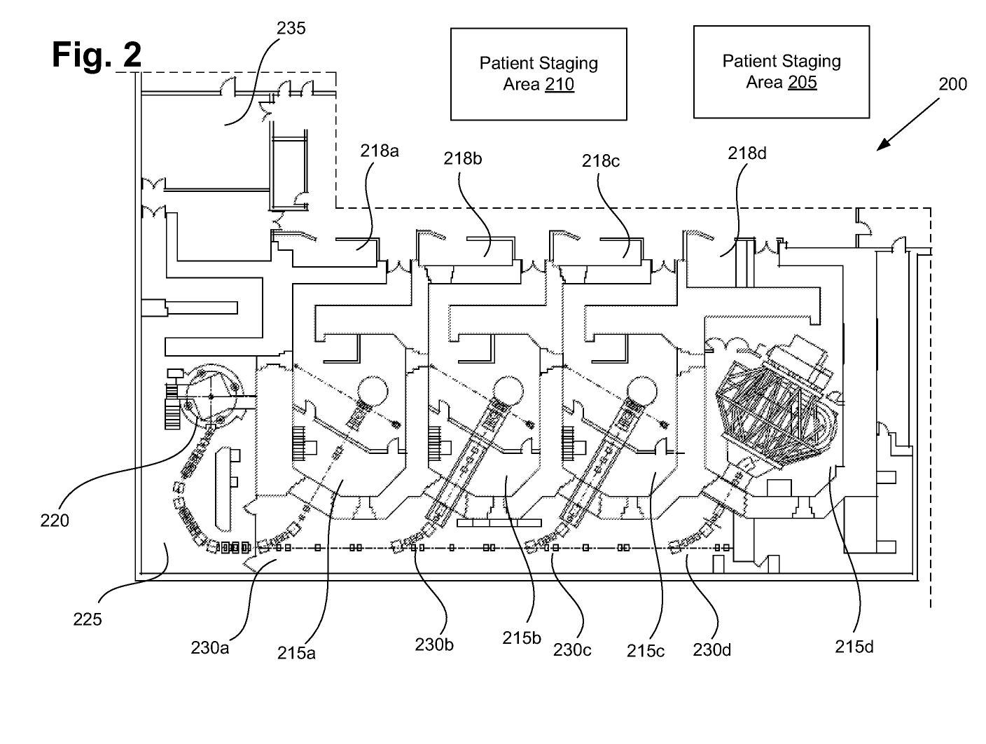

FIG. 2 illustrates one embodiment of a system that can be embedded or integrated into a multi-room radiation medical center where a single radiation source is shared between several treatment rooms. However, the techniques and methods described herein may be beneficially applied to medical centers having more or fewer rooms or to those centers that employ a different shared resource.

In a multi-room medical center 200 the reception or waiting room 205 hosts the process whereby patients wait until they can be transferred to the staging area. It also includes the reception function.

A patient staging area 210 embodies the preparation of patients for the specific therapy to be conducted in a treatment room. Patient staging is where patients dress or undress for treatment, and where interactions with the nursing staff take place. The patient staging process acts as the queue for the treatment process.

From patient staging, a patient proceeds into one of the treatment rooms. In FIG. 2, there are four treatment rooms 215a, 215b, 215c, and 215d. The treatment process includes all of the functions that occur within a treatment room, including patient setup and irradiation. By way of example, in FIG. 2 the radiation source is a cyclotron. Since a single radiation source is typically shared between several treatment rooms in a multi-room radiation medical center, each treatment room has a control room (218a, 218b, 218c, and 218d). From the control room, medical center personnel may monitor the patient during treatment and monitor and/or control equipment in the treatment room. In particle therapy it is customary to designate a treatment room based upon the relationship of the beam to the patient. As the number of treatment rooms is increased, the relative number of each type of treatment room can change. The treatment process acts as a queue for the radiation source.

Each treatment room is appropriately connected to the shared source of radiation, which is integral to the radiation source process. In the exemplary medical center 200, the shared source of radiation is a particle beam generated by the cyclotron 220. The particle beam generated by the cyclotron 220 is directed along a beam line 225 into each of the treatment rooms respectively using switching magnets 230a, 230b, 230c, and 230d. A beam operator in the main control room 235 operates the cyclotron and beam line. The beam operator will monitor the operation of the cyclotron, tune the particle beam characteristics for a patient specific dose, and align the beam line and switching magnets to provide the particle beam to a treatment room.

With proper coordination of the radiation source and treatment room operations it may be possible to reduce the amount of time that the patients must wait for shared resources, such as the radiation beam. The underlying principles of the queuing system are to measure the work flow process continuously and automatically, analyze the measurements to determine the factors that correlate to the outcomes desired, identify potential resource conflicts in a work flow process, and automate feedback loops to control the work flow process. The result is the medical center staff is provided with real-time information to guide their work, improve their effectiveness and minimize the patient waiting time through changing the sequence and managing the timing of tasks in a work flow process.

With proper coordination of the radiation source and treatment room operations it may be possible to reduce the amount of time that the patients must wait for shared resources, such as the radiation beam. Hereby disclosed is a computer implemented method of managing a particle therapy medical center, comprising: monitoring real-time information about a current status of patients, employees, waiting rooms, treatment rooms, and a radiation source; analyzing probability distributions for each step of a treatment process in each treatment room of the medical center; and directing a particle beam from the radiation source to a specific treatment room based on the probability distributions to reduce the total amount of time all patients spend waiting for treatment.

The method for determining the current status of patients further comprises: positioning at least one patient badge with passive radio frequency identification (RFID) tag, wherein the at least one patient badge has a unique tag ID containing encoded information which can be decoded; interrogating the RFID tags via an RFID interrogator system positioned proximate to an intended path of the patients along corridors and rooms of the medical center; and determining the location of the patients in the medical center based on the interrogating step.

At least one patient badge with RFID tag is positioned by securing to a patient, a patient's clothing or a patient's transport means, thus providing enhanced situational awareness to staff as to the position of patients in the medical center.

A patient's transport means is selected from a cart, bed, wheelchair, walker or anesthesia bed.

The RFID interrogator system provides the capability of determining the location of the patient in the proximate environment based on the interrogation of the passive RFID tags, wherein said environment comprises a patient surface movement area of a medical center. This provides enhanced situational awareness to staff as to the position of patients in the medical center.

The computer implemented method and system described herein enables the capability of predicting beam priority of a radiation source in a medical center as well as tracking and directing work flow in a particle therapy medical center. The following example illustrates the center operation and patient movement through the various treatment stages.

### Prior to Arrival at the Center

The patient, at any time, can check their schedule on a home computer or mobile device. Their projected treatment time is continuously updated. The patient can elect to receive an email or text message at a configured time in advance of their (updated) treatment time, so that they do now have to commit to leaving home or work prematurely.

The home/work patient portal also enables the patient to correspond with their therapy team. If they need attention, they may request it in advance so that once they show up at the center there is a system awareness of their needs (e.g. the nurse can have a prescription, or nutritional information, available in advance).

### At the Center

During their first visit to the center, each patient is issued a patient identification badge that contains a radio frequency identification (RFID) antenna. Each patient badge has a unique tag ID containing encoded information which can be decoded. On subsequent visits, if the patient has his badge, as soon as the patient enters the waiting area his presence can be automatically registered. The system now recognizes the patient as part of the present state of the center.

The present state of the center is the set of parameters that includes a description of where patients and staff are located, an interpretation of what they are doing, and the set of resources that they are using. Whenever any patient moves from one area of the center to another, their location can be updated in the state memory of the system. Whenever the system present state changes, projections (predictions) of the future state of the center can be updated. The term “state” is not limited to only people and their location, but also the status of hardware and software. For instance, a patient in the lobby can mean something different depending on whether the designated treatment room is occupied or not, or whether they have a consultation appointment or a treatment appointment, or whether it is their first treatment or last treatment.

The future state of the center is a set of parameters that include predictions for when and where patients will be, what they will be doing, and what resources (e.g. proton beam, examination room, physician) will be required to provide the proper service to them.

### The Present and Future States

The current state can be determined from the known facts provided by the monitoring system 103. The future state can be predicted from the present state, knowing the statistical likelihood of all possible outcomes. The statistical information can be based on the body of information previously gathered by the monitoring system 103 and analyzed by the analysis system 104.

The information may also take the form of estimated values. Estimated values may be particularly useful when new equipment, personnel or patients enter center operations. Until actual data is collected from the new equipment, personnel or patient, average or statistically relevant data may be substituted into the prediction model.

Additionally or alternatively, the information may be based on actual prior patient data for that specific patient. In this case, the treatment room preparation time values are based on the prior times recorded from that specific patient's prior treatments. The information used may also be from a similar patient class such as men aged 40-50 or prostate treatments in treatment room 2.

Given predictions of the future states, and an analysis of previous control/response interactions, strategies for how to influence staff behavior can be prepared so that the likely outcomes are consistent with center objectives.

### What the System Does Overnight or Outside of “Operation Hours”

Overnight or outside of operation hours, the analysis system can update its statistical database with the data logged during the previous day or during a specified prior period (e.g., the prior week, month, or period of hours or minutes). The analysis system can query the center schedule for the upcoming day or time period. The analysis system can simulate the center activity for the upcoming day, thousands of times, using probability-based models based on data gathered previously at the center. Performance outcomes are analyzed and statistically-likely defects are identified. Defects are unwanted outcomes (e.g., a patient waits too long in the treatment room before the proton beam becomes available).

The analysis system can prepare a mitigation strategy to minimize the likelihood of a defect (the likelihood that a patient experiences an unwanted outcome such as waiting too long for a resource). The mitigation strategy is often a simple micro-shifting of the center schedule. For instance, a set of instructions to the therapy team to bring the patient into the treatment room a few minutes earlier or a few minutes later than the scheduled time.

### During the Treatment Day

Once the patient is in the center, it is immediately possible to predict the progression of the patient through the set of activities that comprise the rest of his or her treatment for the day. The prediction is possible because the probability (statistical) distribution that describes the time required to perform each step has been measured many times previously. The analysis system is self-learning. As more data is recorded the probability distributions become more refined and more accurate.

Every time the patient completes a step in the treatment process, the statistical uncertainty in the time required to perform that step is eliminated, and predictions for when subsequent steps will be completed become more accurate. The predictions can be scoped as deeply as the statistics permit. For a patient who has received several treatments already, sufficient statistical data might be present so that the predictions can be tailored to that individual's known capabilities. Otherwise, aggregated probability distributions that address the patient generically (according to age, or by diagnosis, etc) can be used. It is the function of the analysis system to determine what factors correlate with system performance. For example, does the time it takes for a patient to gown depend on the patient diagnosis, the patient age, or other health factors present in the patient? Which of these factors are most strongly correlated with each step of the patient's transit through the treatment process?

### The Patient Flow

Once the patient has arrived at the medical center his or her presence is known by the therapy team. If the patient has an appointment the staff at the nursing station is notified. The nurse's interface allows them to determine whether the patient's physician is available, whether the examination room is available, and if sufficient time is available to complete the appointment. Once the patient is known to be in the waiting room the therapy assistant is alerted when the optimal time arises to bring them back to the treatment area. Adjustments can be automatically made if the patient must gown prior to treatment.

Once gowned, the patient can proceed to the staging area on the treatment corridor. The therapy team can be made aware of the patient's status and is able to start or delay the beginning of the treatment preparation (when they bring the patient into the treatment room) in accordance with the suggestions made by the control system 105.

When the patient enters the treatment room the control system 105 can predict the time that the patient will be ready to receive the proton beam for treatment. The calculation can be done in real-time, and simultaneously across all four treatment rooms.

In the treatment room, the steps required and the duration of the preparatory process can vary just as the type of treatment can vary between patients. Therefore, the monitoring system 103 functionality of the queuing system also tracks the steps taking place in the treatment room, including but not limited to, the setup and positioning, the x-ray verification and the couch adjustments. Every time a task is completed the present state of the center is updated and the control system 105 recalculates the future state. With every successive completed step, the accuracy of the beam demand prediction improves.

One of the functions of the control system 105 is to adjust the pace of activities in each treatment room so that the likelihood of beam demand conflicts (i.e., when two or more treatment rooms request the beam at the same time) is minimized. The operator of the shared particle beam accelerator is constantly updated with the progress in each of the four treatment rooms. When the control system 105 makes a definitive assessment of which treatment room will be ready to receive the proton beam first, the radiation source operator will preemptively start to prepare the beam for that patient and that room in anticipation of the beam request. When the patient setup is complete, the beam will therefore be prepared and ready when the therapists request it.

The underlying principles of the queuing system and patient intake management that provide the means for achieving the objectives are the ability to: measure all of the processes continuously and automatically, analyze the measurements to determine the factors that correlate to the outcomes desired, and automate feedback loops to control the processes. The result is the medical center staff is provided with real-time information to guide their work, improve their effectiveness and minimize the patient waiting time.

Although the system and method herein has been discussed with regard to its specific application to a particle therapy medical center for radiation treatment these inventive aspects may have numerous other applications. For example, it may be used in medical centers that use any shared resources such as equipment or personnel.

As indicated heretofore, aspects of this invention pertain to specific “methods” and “method functions” implementable on computer systems. Those of ordinary skill in the art should readily appreciate that computer code defining these functions can be delivered to a computer in many forms; including, but not limited to: (a) information permanently stored on non-writable storage media (e.g., read only memory devices within a computer or CD-ROM disks readable by a computer I/O attachment); (b) information alterably stored on writable storage media (e.g., floppy disks and hard drives); or (c) information conveyed to a computer through communication media such as telephone networks or other communication networks. It should be understood, therefore, that such media, when carrying such information, represent alternate embodiments of the present invention.

Having described preferred embodiments of the invention, it will now become apparent to one of ordinary skill in the art that other embodiments incorporating their concepts may be used. It is felt therefore that these embodiments should not be limited to disclosed embodiments, but rather should be limited only by the spirit and scope of the appended claims. It will be understood that various changes in the details, materials, and arrangements of the parts which have been described and illustrated above in order to explain the nature of this invention may be made by those skilled in the art without departing from the principle and scope of the invention as recited in the following claims.

What is claimed is:

1. A computer implemented system for tracking and directing work flow in a particle therapy medical center, comprising:
a monitoring system configured to receive real-time information about the current actions of people, hardware, and software at the medical center from the people, hardware, and software at the medical center;
an analysis system configured to analyze the information received by the monitoring system to construct probability distributions for each step in a treatment process of the medical center; and
a control system configured to use the probability distributions from the analysis system to predict demands on shared resources, provide strategies for dealing with the demands, and output the demands and strategies.

2. The system according to claim 1, wherein the monitoring system further comprises:
a radio frequency identification (RFID) interrogator system positioned proximate to an intended path of a patient along corridors and rooms of the medical center; and,
a plurality of passive RFID tags each having a unique tag ID containing encoded information which can be decoded, the RFID tags being positioned on patient badges, wherein the RFID interrogator system provides the capability of determining the location of the patient in said proximate environment based on the interrogation of said passive RFID tags.

3. The system according to claim 2, wherein said environment comprises a patient surface movement area of a medical center, thus providing enhanced situational awareness to staff as to the position of patients in the medical center.

4. The system according to claim 2, wherein said RFID interrogator system, comprises:
an interrogator element positionable within operable ranges of a plurality of said RFID tags during operation of the patient location system; and
a computer system operatively connected to said interrogator element for managing and organizing responses from said RFID tags to provide patient location data.

5. The system according to claim 2, wherein said RFID interrogator system further comprises a database.

6. A computer implemented method of managing a particle therapy medical center, comprising:
monitoring real-time information about a current status of patients, employees, waiting rooms, treatment rooms, and a radiation source;
analyzing probability distributions for each step of a treatment process in each treatment room of the medical center; and
directing a particle beam from the radiation source to a specific treatment room based on the probability distributions to reduce the total amount of time all patients spend waiting for treatment.

7. The method according to claim 6, wherein current status of patients further comprises:
positioning at least one patient badge with passive radio frequency identification (RFID) tag, wherein the at least one patient badge has a unique tag ID containing encoded information which can be decoded;
interrogating the RFID tags via an RFID interrogator system positioned proximate to an intended path of the patients along corridors and rooms of the medical center; and
determining the location of the patients in the medical center based on the interrogating step.

8. The method according to claim 7, wherein said at least one patient badge with RFID tag is positioned by securing to a patient, a patient's clothing or a patient transport, thus providing enhanced situational awareness to staff as to the position of patients in the medical center.

9. The method according to claim 8, wherein said patient transport is selected from the group consisting of a cart, a bed, a wheelchair, a walker, and an anesthesia bed.

10. A computer implemented method for predicting beam priority of a radiation source in a medical center, comprising:
monitoring real-time information about a current status of patients, employees, waiting rooms, treatment rooms, and a radiation source;
analyzing probability distributions for each step of a treatment process in each treatment room of the medical center; and
directing a particle beam from the radiation source to a specific treatment room based on the probability distributions to reduce the total amount of time all patients spend waiting for treatment.

11. The method of claim 10, wherein current status of patients further comprises:
positioning at least one patient badge with passive radio frequency identification (RFID) tag, wherein the at least one patient badge has a unique tag ID containing encoded information which can be decoded;
interrogating the RFID tags via an RFID interrogator system positioned proximate to an intended path of the patients along corridors and rooms of the medical center; and
determining the location of the patients in the medical center based on the interrogating step.

12. The method of claim 11, wherein at least one patient badge with RFID tag is positioned by securing to a patient, a patient's clothing or a patient transport, thus providing enhanced situational awareness to staff as to the position of patients in the medical center.

13. The method of claim 12, wherein said patient transport is selected from the group consisting of a cart, a bed, a wheelchair, a walker, and an anesthesia bed.
